(19) United States
(12) Patent Application Publication
(10) Pub. No.: US 2003/0088569 A1
(43) Pub. Date: May 8, 2003

(54) Configuring access to database

(76) Inventor: Amy L. Rubert, Boise, ID (US)

Correspondence Address: TROP PRUNER & HU, PC, 8554 KATY FREEWAY, SUITE 100, HOUSTON, TX, 77024, US

(21) Appl. No.: 09/837,980

(22) Filed: Apr. 19, 2001

(51) Int. Cl. G06F 7/00

(52) U.S. Cl. 707/100

(57) ABSTRACT

A way of configuring access to a database is provided. An apparatus is provided that comprises a storage unit and a controller communicatively coupled to the storage unit. The controller is adapted to store a master profile for accessing the database in the storage unit and store a user access name to access the database in the storage unit. The controller is further adapted to configure a user access level based on the master profile and the access name.

### TECHNICAL FIELD

This invention relates generally to databases, and, more particularly, to configuring access to databases.

### BACKGROUND

Business organizations routinely rely on database applications for a variety of reasons, including maintaining employee records, payroll tracking, inventory tracking, and the like. Given the confidential nature of the contents stored in these databases, it is sometimes desirable to restrict user access to them. The term “database,” as utilized herein, may include any repository of information, where restricted access to the stored information may be desirable. Some common examples of database applications include, but are not limited to, Oracle, Dbase III, and the like.

Generally, it is the system administrators of the organizations that are faced with the arduous task of controlling access to databases. Controlling access to databases, in one embodiment, may entail creating user accounts and then associating access levels to the user accounts. The access levels may, for example, restrict a user's access to information stored in the database. The information may be restricted by limiting the user's access to selected forms in the database application, for example.

The level of access granted to users may vary from one user to another, depending, for example, on the job responsibilities assigned to that user. As an example, a first user may be granted access to a first preselected set of forms of the database and another user to be granted access to a second preselected set of forms. The process of configuring access to databases may sometimes be a cumbersome process for system administrators, particularly if the level of access may need to be defined on a user by user basis (i.e., the users do not necessarily all share the same access).

Thus, what is needed is a more robust manner of configuring access to databases.

### SUMMARY

A method and apparatus are provided for configuring access to a database. The apparatus comprises a storage unit and a controller communicatively coupled to the storage unit. The controller is adapted to store a master profile for accessing the database in the storage unit and store a user access name to access the database in the storage unit. The controller is further adapted to configure a user access level based on the master profile and the access name.

Other features and embodiments will become apparent from the following description, from the drawings, and from the claims.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a communications system in accordance with one embodiment of the present invention;

FIG. 2 is a stylized block diagram of a server system having a database in accordance with one embodiment of the present invention that may be implemented in the communications system of FIG. 1;

FIG. 3 is an exemplary form that may be accessed through the database residing on the server system of FIG. 2, in accordance with one embodiment of the present invention;

FIG. 4 is a diagram of a method that may be implemented in the server system of FIG. 2, in accordance with one embodiment of the present invention;

FIGS. 5 and 6 are exemplary forms that may be accessed through the database residing on the server system of FIG. 2, in accordance with one embodiment of the present invention;

FIG. 7 is an exemplary profile that may be employed by the database resident on the server system of FIG. 2, in accordance with one embodiment of the present invention;

FIG. 8 is a flow diagram of an alternative method that may be implemented in the server system of FIG. 2, in accordance with one embodiment of the present invention;

FIG. 9 is an exemplary table that may be employed by the database resident on the server system of FIG. 2, in accordance with one embodiment of the present invention;

FIG. 10 is a flow diagram of a method that may be implemented in the server system of FIG. 2, in accordance with one embodiment of the present invention;

FIG. 11 is a flow diagram of a method that may be implemented in the server system of FIG. 2, in accordance with one embodiment of the present invention;

FIG. 12 is a flow diagram of a method that may be implemented in the server system of FIG. 2, in accordance with one embodiment of the present invention; and

FIG. 13 illustrates exemplary profiles that may be utilized to configure user access to the database resident on the server system of FIG. 2, in accordance with one embodiment of the present invention.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

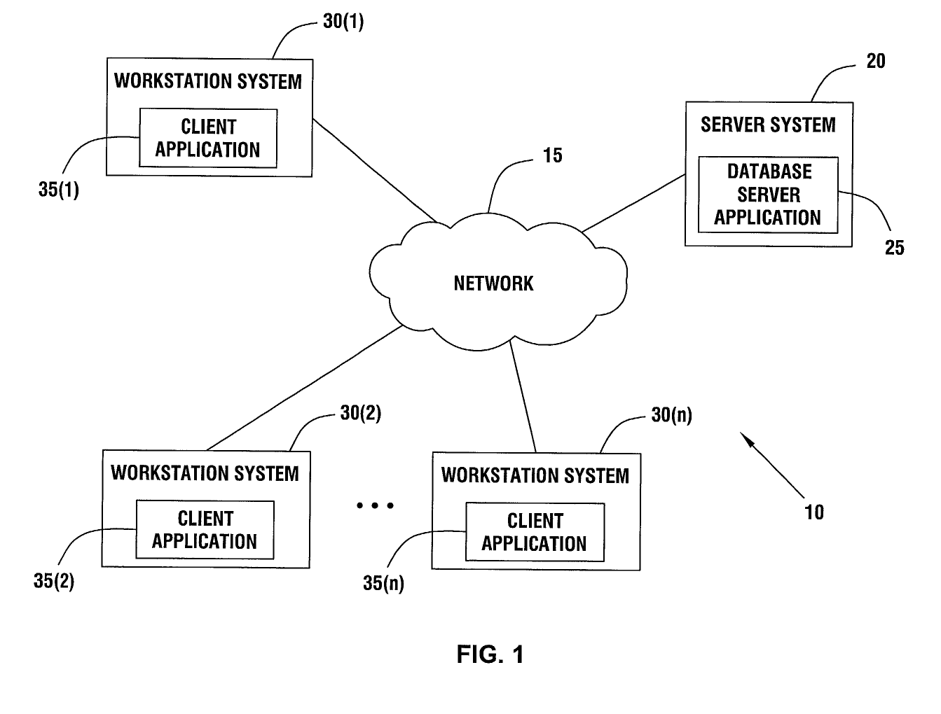

Referring now to FIG. 1, a communications system 10 includes a network 15 that may have one or more systems coupled to the network 15. In one embodiment, the network 15 may be a public network, or, alternatively, a private network. A public network may be an Internet network, for example. The network 15 may be a local area network (LAN), wide area network (WAN), and the like. As utilized herein, the term “network” may refer to one or more communications networks, channels, links, or paths and systems or devices used to transfer data over such networks, channels, links or paths.

The communications system 10 in the illustrated embodiment includes a server system 20 that has a database server application 25 stored therein. The communications system 10 in the illustrated embodiment includes one or more workstation systems 30(1-n) coupled to the network 15, wherein the workstation systems 30(1-n) may each have a client application 35(1-n).

In one embodiment, the server system 20 may be a network server that controls and manages files that are accessed by the workstations 30(1-n) over the network 15. In another embodiment, the server system 20 allows the client application 35(1-n) to access files or records that are managed by the database server application 25. The client application 35(1-n), in one embodiment, may access the files or records under the control of the database server application 25 over the Internet, through a web-based interface, for example. In another embodiment, the client application 35(1-n) may interface with the database server application 25 over a telnet session. An example of the database server application 25 may be Oracle database application, wherein the client application 35(1-n) may transmit or receive structured query language (SQL) messages to and from the Oracle database application.

In accordance with one embodiment of the present invention, as is described in more detail below, a system administrator may configure access to the database server application 25 for one or more users. For example, in one embodiment, the system administrator may create a profile that defines a user access level for each user that accesses the database server application 25. The term “system administrator,” as utilized herein, may include any person having access to the database server application 25 of the server system 20.

In other embodiments of the present invention, as is described in more detail below, a system administrator may control user access to the database server application 25 in one of several ways. For example, in one embodiment, a user's access to selected information that is under the control of the database server application 25 may be restricted by limiting the forms or panels to which the user may have access. In another embodiment, again as described below, a user's access to selected information may be controlled by restricting the user access to one or more fields within the forms or panels.

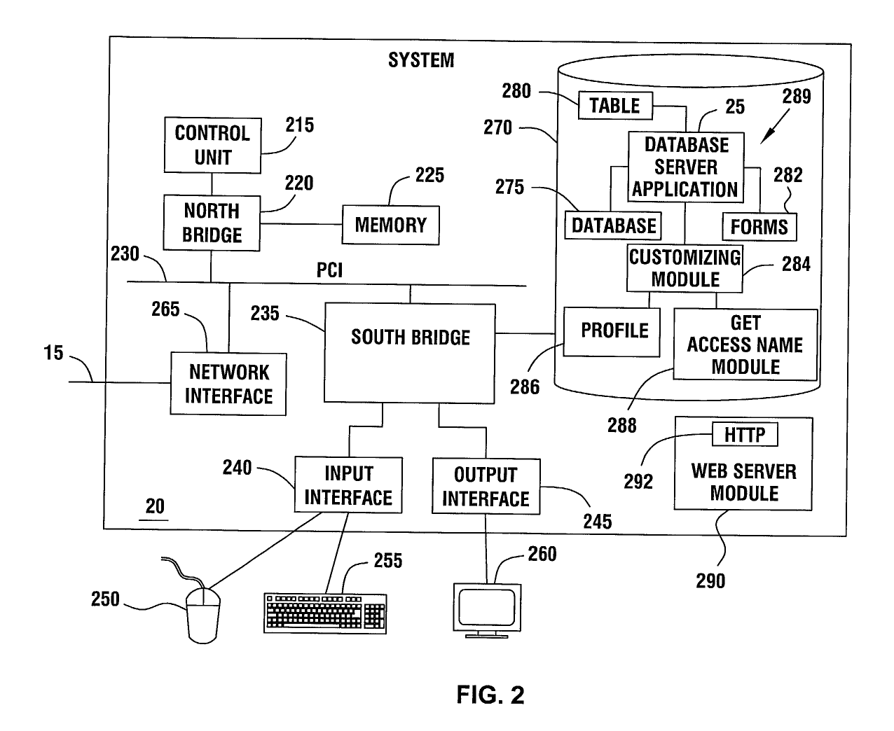

Referring now to FIG. 2, a stylized block diagram of the server system 20 is shown in accordance with one embodiment of the present invention. The server system 20 may be a laptop, desktop, main frame, a network sever, or any other processor-based system.

The server system 20 comprises a control unit 215, which in one embodiment may be a processor. The control unit 215 in one embodiment may be capable of interfacing with a north bridge 220. The north bridge 220 may provide memory management functions for memory 225, as well as serve as a bridge to a peripheral component interconnect (PCI) bus 230. The server system 20 includes a south bridge 235 coupled to the PCI bus 230. The south bridge 235 may be coupled to an input interface 240 and an output interface 245. The input interface 240 may interface with one or more input devices, such as a mouse 250 or a keyboard 255. The output interface 245 may, in one embodiment, interface with a display device 260. The server system 20, in one embodiment, includes a network interface 265 that may be coupled to the PCI bus 230. The network interface 265, in one embodiment, may include a network card.

The server system 20 includes a storage unit 270 that is coupled to the south bridge 235, in one embodiment. The storage unit 270 may have the database server application 25 stored therein, in one embodiment. The storage unit 270, in one embodiment, includes a database block 275 that may contain information that is accessible by the database server application 25. The database block 275, for example, may be a repository where the database server application 25 stores information, such as employee records, inventory items, and the like. The database server application 25 may use a table 280 to store user access information, as described in more detail below. In one embodiment, the database server application 25 may have one or more forms (or panels) stored in the forms block 282, where users access information stored in the database block 275 through the one or more forms. In one embodiment, as described in more detail below, a system administrator may grant or deny users access to selected forms stored in the forms block 282.

In accordance with one embodiment of the present invention, the storage unit 270 may include a customizing module 284 that may be executed when a user selects a particular form from the forms block 282. The customizing module 284, in one embodiment, uses a get access name module 288 and one or more profiles stored in a profile block 286 to restrict a user's access to selected fields of the forms stored in the forms block 282. The interaction among the database server application 25, customizing module 284, and the get access name module 288 is described in more detail below. The information stored in the database block 275, table 280, and/or forms block 282, may be encrypted, in one embodiment, to prevent unauthorized access.

For illustrative purposes, the table 280, forms block 282, database block 275, profile block 286, and modules 284, 288 are shown as discrete blocks or modules; although, it should be appreciated that in alternative embodiments these blocks or modules may be part of a single application or routine. In one embodiment the modules 284, 288 and blocks 275, 282, 286 may be implemented in hardware, software, or a combination therefor. One or more of the blocks 275, 282, 286, modules 284, 288, and/or the database server application 25 may comprise a database 289. Thus, any references made hereinafter to the term “database 289” may include one or more the aforementioned blocks 275, 282, 286, modules 284, 288, and database server application 25.

The storage unit 270 may include in one embodiment an operating system, such as the WINDOWS® operating system provided by Microsoft Corporation. Additionally, in one embodiment, the storage unit 270 may include device drivers for interfacing with the mouse 250, keyboard 255, display device 260, and network interface 15. The database server application 25, operating system, and other software modules may be loaded for execution on the control unit 215.

The server system 20, in one embodiment, includes a web server module 290, which may be capable of receiving requests over the data network 15 and responding to such requests. For example, the web server module 290 may include an HTTP (Hypertext Transfer Protocol) service routine 292 that is capable of receiving HTTP requests over the network 15, as well as sending HTTP responses over the network 15. HTTP specifies how a client and server may establish a connection, how the client may request data from the server, how the server may respond to the request, and how the connection may be closed. One version of HTTP is described in RFC 2068, entitled “Hypertext Transfer Protocol-HTTP/1.1,” dated January 1997. In one embodiment, the web server application 290 allows the client application 35(1) (see FIG. 1) to communicate with the database server application 25 of the server system 20 over the Internet. In one embodiment, the web server module 290 and the HTTP service routine 292 may be stored in the storage unit 270 or in another storage unit (not shown).

For clarity and ease of illustration, only selected functional blocks of the server system 20 are illustrated in FIG. 2, although those skilled in the art will appreciate that the server system 20 may comprise additional or fewer functional blocks. Additionally, it should be appreciated that FIG. 2 illustrates one possible configuration of the processor-based system 20 and that other configurations comprising different interconnections may also be possible without deviating from the spirit and scope of one or more embodiments of the present invention. For example, in an alternative embodiment, the output interface 245 may interface with the north bridge 220 (as opposed to the south bridge 235). As an additional example, the storage unit 270 may communicate with the south bridge 235 over the PCI bus 230. Similarly, other elements of the server system 20 may be configured differently.

Although not so limited, one or more embodiments of the methods described herein may be implemented within Oracle database application. As such, whenever helpful, occasional references to Oracle database application may be made for the benefit of the reader. Such references, however, should not be construed to limit the embodiments of the present invention to any particular database application, including Oracle database application.

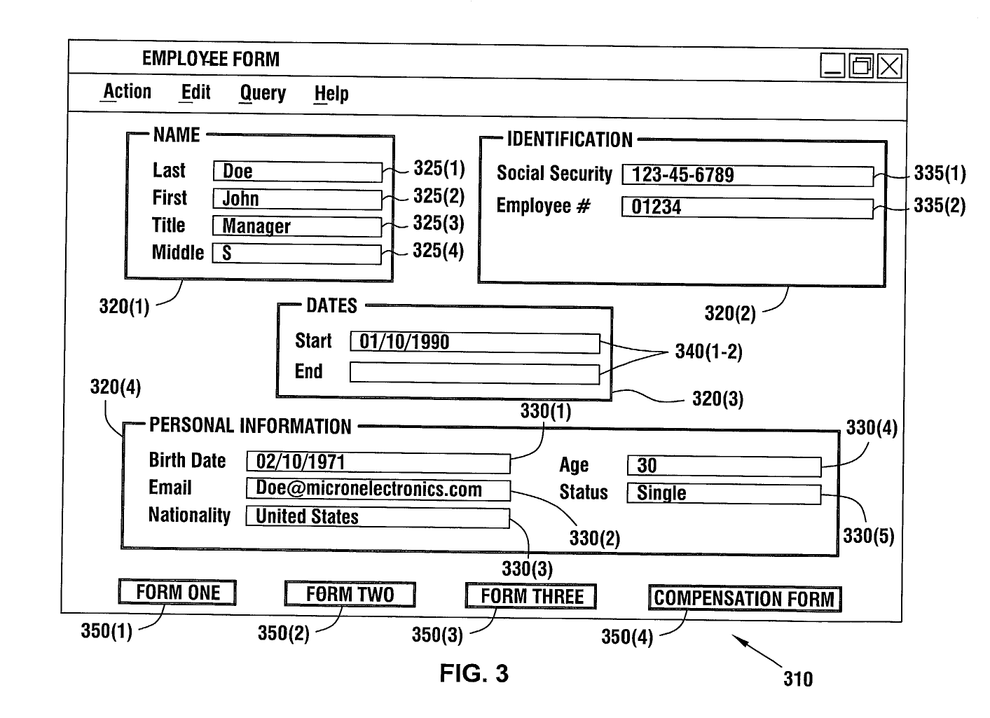

Referring now to FIG. 3, an exemplary form 310, entitled “EMPLOYEE FORM,” is shown, in accordance with one embodiment of the present invention. In one embodiment, the form 310, which may be stored in the forms block 282, is accessed by the database server application 25 and shown on the display device 260 (see FIG. 2). The exemplary form 310 contains a record of an employee, where the record may be stored in the database 289 under the control, for example, of a human resources department of an organization.

The form 310, as shown, includes one or more “blocks” 320(1-4), where each block may contain selected information regarding the employee, grouped according to the “type” of information, in one embodiment. For example, the name block 320(1) includes a plurality of fields 325(1-4) for storing the name of the employee, while the personal information block 320(4) includes a plurality of fields 330(1-5) for storing personal data pertaining to the employee. Similarly, the identification block 320(2) includes fields 335(1-2) that may contain information through which the employee can be readily identified, such as the social security number or employee number. The date block 320(3) may contain fields 340(1-2) for storing the employee's start and termination date.

The exemplary form 310 includes a plurality of form access buttons 350(1-4), which, for example, allow the user to access other forms from the employee form 310. The sequence of accessing another from the “current” (e.g., displayed currently on the display device 260) form is herein referred to as a “task flow.” That is, as shown, the first, second, third, and fourth access buttons 350(1-4) of the form 310 (e.g., the current form) allow the user to respectively access FORM ONE, FORM TWO, FORM THREE, and COMPENSATION FORM, which may be forms that are also stored in the forms block 282, in one embodiment. It may be possible to further access other forms, such as FORM FIVE, from FORM ONE, for example. This sequence of accessing forms (e.g., from EMPLOYEE FORM 310 to FORM ONE to FORM FIVE) is one example of a “task flow.”

As shown, the exemplary form 310 allows a user to access a variety of other forms using the buttons 350(1-4) as well as access (e.g., view, edit) any of the fields 325(1-4), 330(1-5), 335(1-2), and 340(1-2) of the form 310. Thus, in one embodiment, FIG. 3 illustrates a user having full authority to access all of the desired fields in the form 310 or access any of the forms through the buttons 350(1-4). In some instances, however, as described below, it may be desirable to restrict the user's ability to access selected fields and/or access to other forms from a “base” form, where the “base” form, in one embodiment, comprises the lowest level form from which other forms may be accessed.

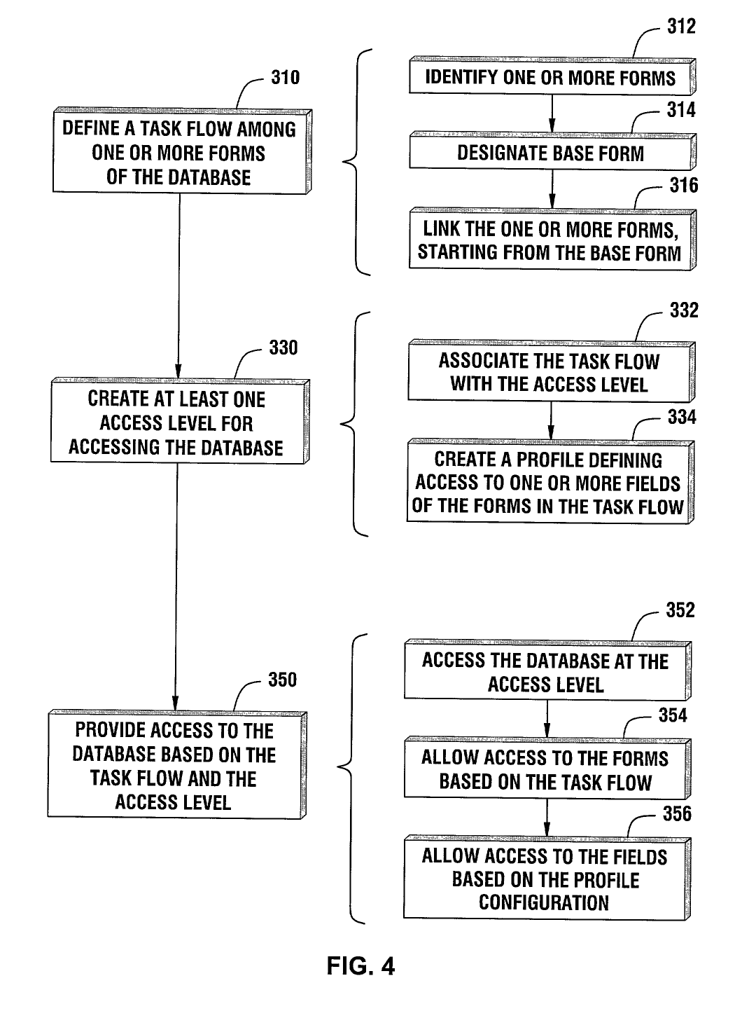

Referring now to FIG. 4, a flow diagram of a method that may be implemented in the server system 20 of FIG. 2 is illustrated, in accordance with one embodiment of the present invention. A system administrator defines (at 310) a task flow among one or more forms stored in the form block 282 of the database 289. The task flow, as mentioned above, may refer to a sequence of forms that may be accessed, starting from the base form. Defining (at 310) a task flow may, in one embodiment, include identifying (at 312) one or more forms, designating (at 314) a base form of the one or more forms, and linking (at 316) the one or more forms, starting from the base form.

A system administrator may create (at 330) at least one access level for accessing the database 289. The “access level” may, in one embodiment, be an account created for a user to access selected information within the database 289. In one embodiment, the “access level” may correspond to a “responsibility” in the context of Oracle database application. In one embodiment, creating (at 330) the access level may comprise associating (at 332) the task flow defined (at 310) with the access level. Creating (at 330) the access level, in one embodiment, also include creating (at 334) a profile that defines access to one or more fields of the forms in the defined (at 310) task flow. That is, the profile may define whether selected fields of the forms in the task flow may be viewable, updateable, and the like.

Based on the defined (at 310) task flow and created (at 330) access level, the database server application 25 provides (at 350) a user access to the database 289. In one embodiment, providing (at 350) access to the database may include providing (at 352) access to the database at the created (at 330) access level. Upon accessing (at 352) the database 289 at the access level, the user is able to access the one or more forms (at 354) of the task flow, starting from the base form. The database sever application 25 may allow (at 356) access to selected fields of the forms in the task flow based on the created (at 334) profile.

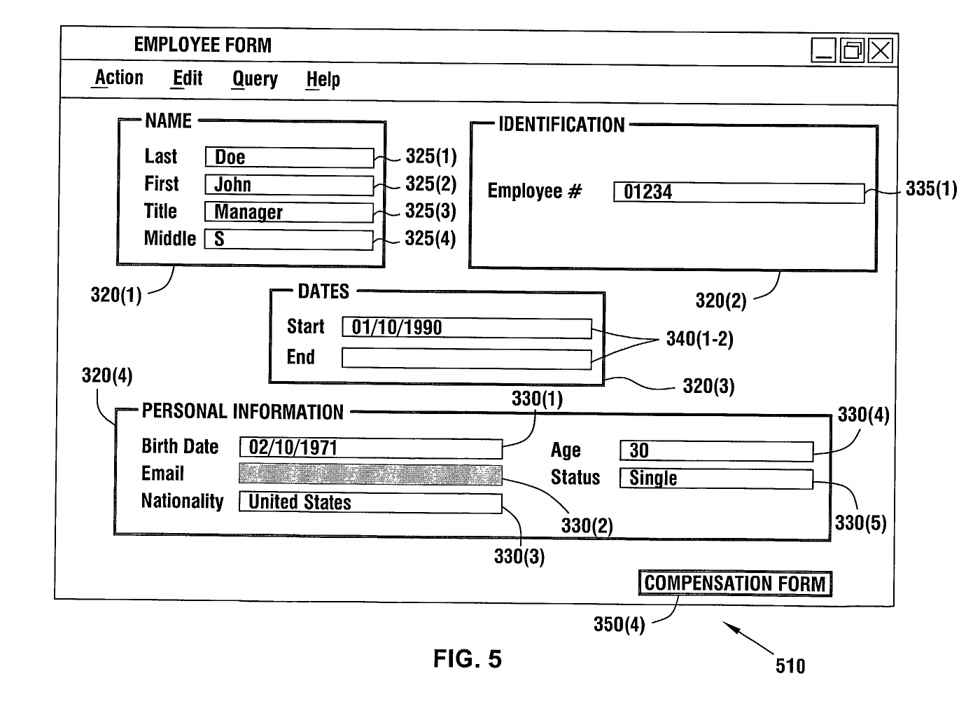

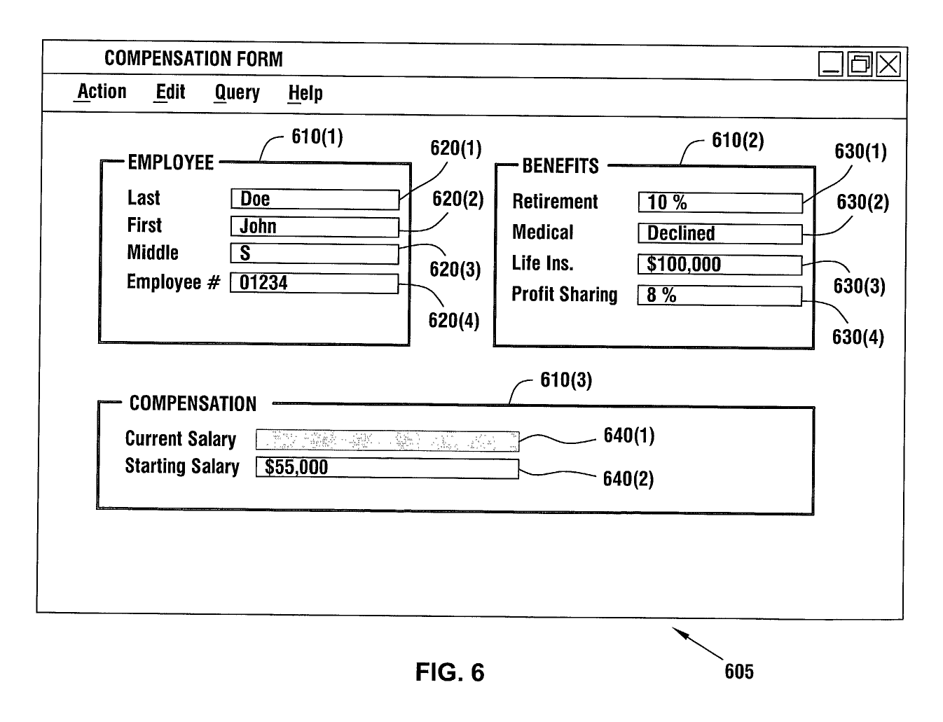

Referring now to FIGS. 5 and 6, one embodiment of forms 510, 605 is shown in accordance with the present invention. The EMPLOYEE form 510 of FIG. 5 is similar to the form 310 of FIG. 3, except that, as described below, access to selected fields and forms are restricted in a manner consistent with one or more embodiments of the present invention. For example, a task flow is defined between the forms of FIGS. 5 and 6, with the EMPLOYEE form 510 of FIG. 5 being designated as the base form from which the COMPENSATION form 605 of FIG. 6 may be accessed using the compensation form button 350(4). Accordingly, in contrast with the form 310 of FIG. 3, in the illustrated embodiment, only the COMPENSATION form 605 may be accessed from the EMPLOYEE form 310 using the button 350(4), as the buttons 350(1-3) (see FIG. 6) to access FORM ONE, FORM TWO, FORM THREE have been removed from the EMPLOYEE form 510 of FIG. 5.

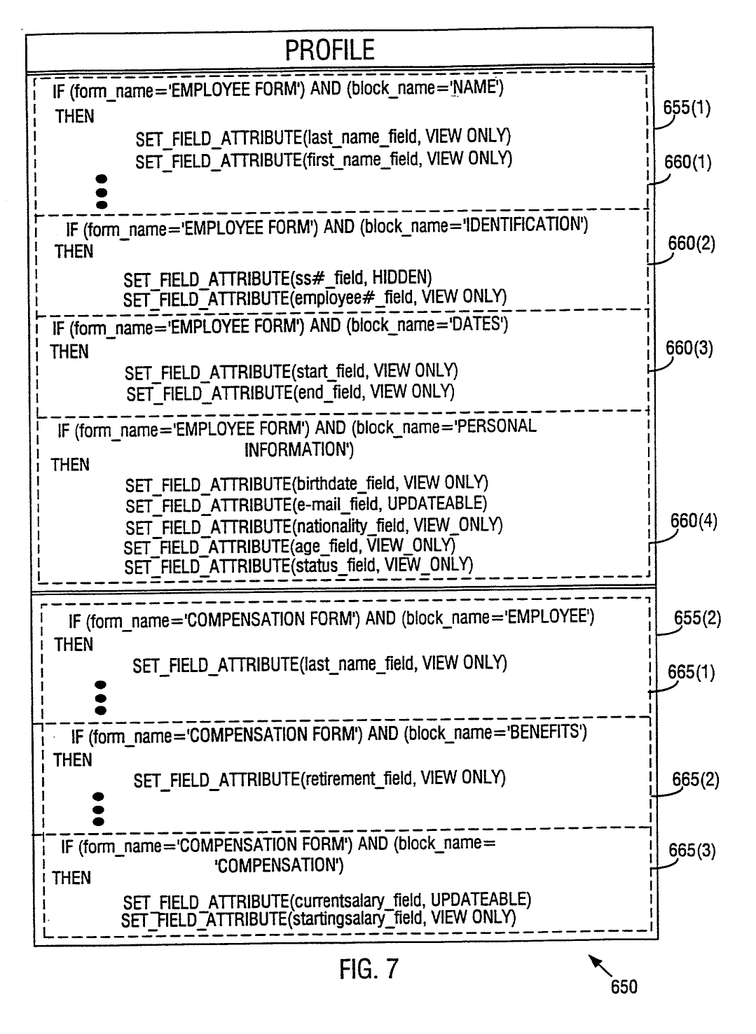

For illustrative purposes, it is herein assumed that an access level has been created to allow a user to access the form 510 of FIG. 5, as well as the form 610 of FIG. 6 through the form 510. Furthermore, it is herein assumed that the access level has an associated profile that defines the access to one or more fields that are accessible to a user. One exemplary profile 650 is illustrated in FIG. 7. As will be described in more detail below, the exemplary profile 650 of FIG. 7 is configured to allow the user access to view all of the fields of the form 510 of FIG. 5 except for the social security field 335(1) (see FIG. 3). As such, when the user accesses the FIG. 5, all fields except the social security field 335(1) are visible to the user, in one embodiment. Selected fields may be hidden from the user for a variety of reasons, including security, privacy, and the like. In one embodiment, instead of the hiding the entire field, only the social security number itself (as opposed to the text “social security” of the field) may be hidden from the user. In addition to allowing a user to view all of the fields (with the exception of the social security field), the profile 650 may be configured to allow a user to update one or more selected fields of the form 510, although in the instant case (as will be described later) the user is allowed to update only the e-mail field 330(2) of the personal information block 320(4).

FIG. 6 illustrates an exemplary COMPENSATION form 605 that may be accessed from the EMPLOYEE form 510 of FIG. 5. The COMPENSATION form 605, in one embodiment, includes an employee block 610(1), benefits block 610(2), and compensation block 610(3). The employee block 610(1) includes information identifying the employee whose compensation information is displayed in the blocks 610(3). For example, the employee block 610(1) includes a plurality of fields 620(1-4) that contain a last name, first name, middle initial, and employee number of the employee identified in the EMPLOYEE form 510 of FIG. 5.

The benefits block 610(2), in one embodiment, includes a retirement field 630(1), medical field 630(2), life insurance field 630(3), and profit sharing field 630(4) for holding information regarding the benefits provided to the employee. Similarly, the compensation block 610(3) contains, in one embodiment, a plurality of fields 640(1-2) that indicate the employee's current salary and the employee's starting salary. The fields 620(1-4), 630(1-4), and 640(1-2) are exemplary fields, as it should be understood that the COMPENSATION form 605 may include additional or fewer fields, depending on the particular implementation.

Referring now to FIG. 7, the exemplary profile 650 includes a plurality of sections 655(1) and 655(2) that further contain a plurality of sub-blocks 660(1-4) and 665(1-3), respectively, in one embodiment. As described in more detail below, the sections 655(1-2) define user access to the forms 510 and 610 of FIGS. 5 and 6, respectively. While the profile 650 includes lines demarcating the sections 655(1-2) and sub-blocks 660(1-4) and 665(1-3), it should be noted, however, that these lines are provided for illustrative purposes only, and that they may not necessarily be part of the profile 650. In one embodiment, the profile 650 may simply comprise a text file that is stored in the profile block 286 of FIG. 2, for example.

The sub-blocks 660(1-4) of the first section 655(1) define user access for the fields in the various blocks 320(1-4) of the form 510 of FIG. 5. For example, the first block 660(1) sets the user access of the last_name_field 325(1) and first_name_field 325(2) of the NAME block 320(1) of the form 510 to “view only,” which means that the user may view these fields but cannot alter their contents. The second block 660(2), for example, defines the user access to the social_security_field 335(1) (see FIG. 3) and the employee #_field 335(2) of the identification block 320(2) of the form 510 as “hidden” and “view only,” respectively. A “view only” access allows a user to view, but not change, the contents of that field, while a “hidden” access prevents the user from being able to even view the social_security_field 335(1). As can be seen with reference to the form 510 of FIG. 5, the social security field 335(1) (compare FIGS. 3 and 5) is not displayed (i.e., is hidden) in the identification block 320(2).

The third sub-block 660(3) of the section 655(1) defines a “view only” access for the start_field 340(1) and end_field 340(2) of the dates block 320(3) of the form 510 of FIG. 5. As such, the user is able to only view, but not change, the fields 340(1-2). The fourth sub-block 660(4) of the section 655(1) defines a “view only” access for the birthdate_field 330(1), nationality_field 330(3), age_field 330(4), and status_field 330(5) of the personal information block 320(4) of the form 510, and an “updateable” access for the e-mail_field 330(2) of the form 510. As such, the user may be able to modify the e-mail address field 330(2), but only view the remaining fields 330(1, 3, 4) of the personal information block 320(4) of the form 510. The e-mail_field 330(2) is highlighted in FIG. 5 to illustrate that it may be updated by the user.

The sub-blocks 665(1-3) of the section 655(2) of FIG. 7 define the user access to the fields in the form 610 of FIG. 6. For example, the sub-blocks 665(1) and 665(2) define “view only” access for the fields in the employee and benefits blocks 610(1-2). As such, the user may be able to view, but not alter the contents of, these fields on the form 610. The sub-block 665(3) defines an “updateable” access for the currentsalary_field 640(1) and a “view only” access for the startingsalary_field 640(2) of the form 610. Thus, the user may be able to alter the contents of the currentsalary_field 640(1), but not the startingsalary_field 640(2), in the illustrated embodiment.

It should be noted that the profile 650 defines exemplary access to the fields in the forms 510 and 610 of FIGS. 5 and 6, respectively, and that such accesses may vary from one implementation to another. Furthermore, the syntax used (e.g., “set_field_attribute”) to set the attributes of the fields in the forms 510 and 610 may be implementation specific. Additionally, attributes other than “view only,” “updateable,” and “hidden” may also be employed in other embodiments. The exemplary profile 650 of FIG. 7 is intended to illustrate one way of controlling access to selected portions of the forms 510, 610 in accordance with one embodiment of the present invention, although the exemplary profile 650 may take other forms that may still be within the scope of one or more embodiments of the present invention.

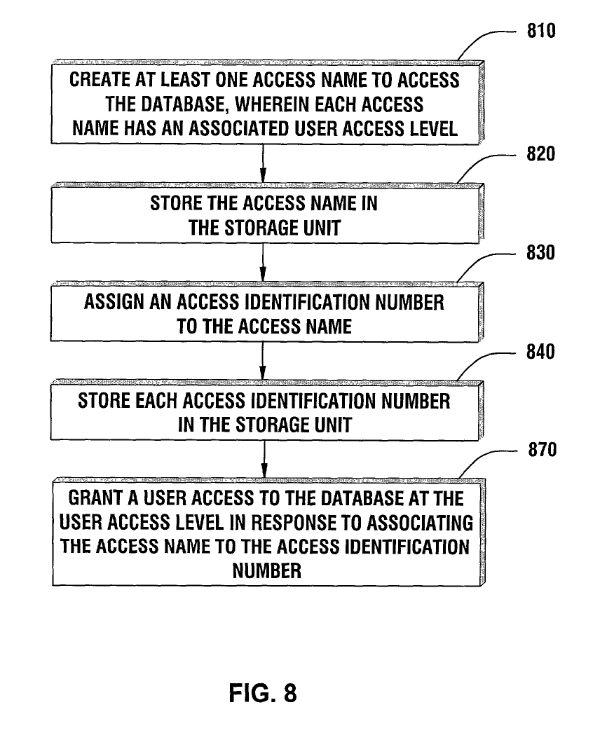

Referring now to FIG. 8, one embodiment of a method that may be implemented on the server system 20 is illustrated. A system administrator creates (at 810) at least one access name (sometimes referred to as “user access name”) to access the database 289, wherein each access name has an associated user access level. In one embodiment, the user access level refers to the level of access a user may have to the database 289, such as restricting the user's access to selected fields in one or more of the forms stored in the forms block 282. In one embodiment, the user access level may be defined in a profile, for example, such as the profile 650 of FIG. 7. The access name of each user access level may be stored (at 820) in the storage unit 270. In one embodiment, creating the access name may correspond to creating a “responsibility” in Oracle database application, wherein a profile may be associated with that responsibility.

The database 289 assigns (at 830) an access identification number to each access name that is created (at 810). In one embodiment, the access identification number may be created by the database 289 for internal referencing (e.g., the database 289 may reference each access name using its internally generated access identification number). In the context of Oracle database application, the access identification number may be a responsibility identification (ID) that is generated each time a new responsibility is created. The access identification number may be stored (at 840) in the storage unit 270.

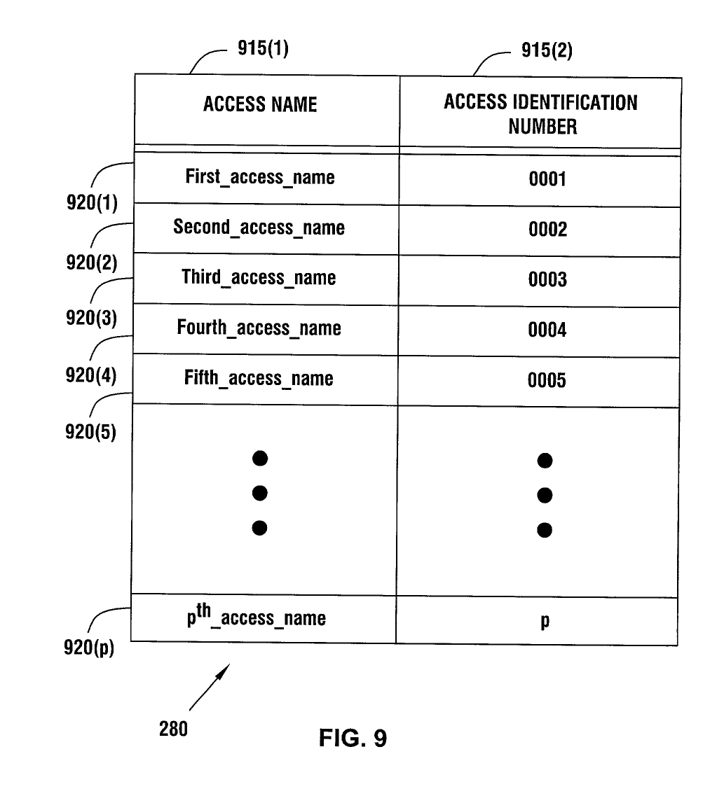

In one embodiment, each access name and its corresponding access identification number may be stored in the table 280 (see FIG. 2). One embodiment of the table 280 is illustrated in FIG. 9, which is described in more detail below.

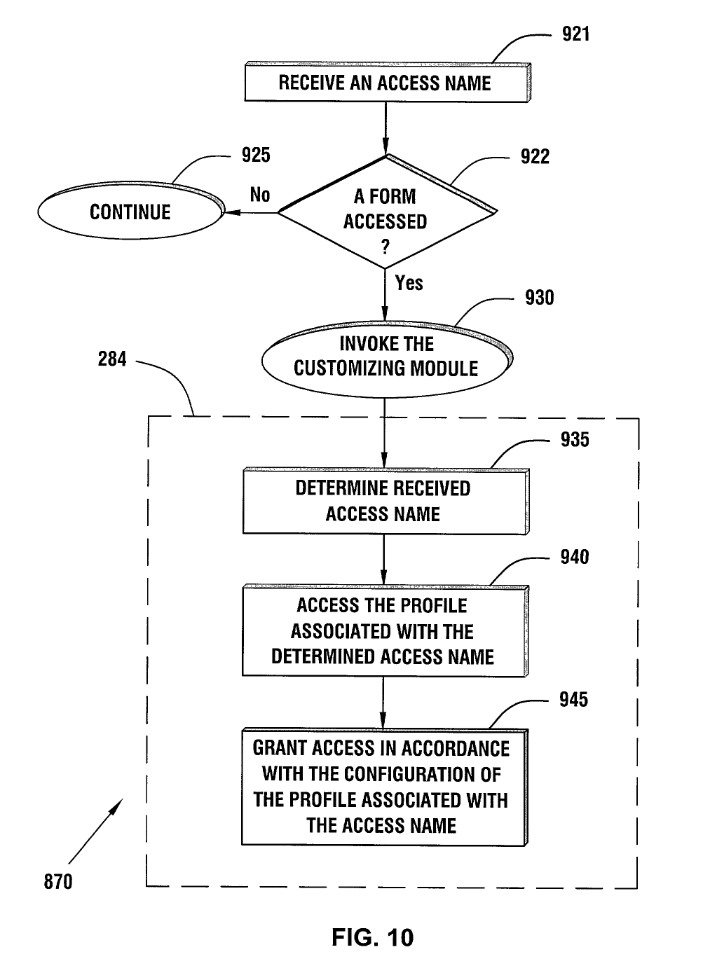

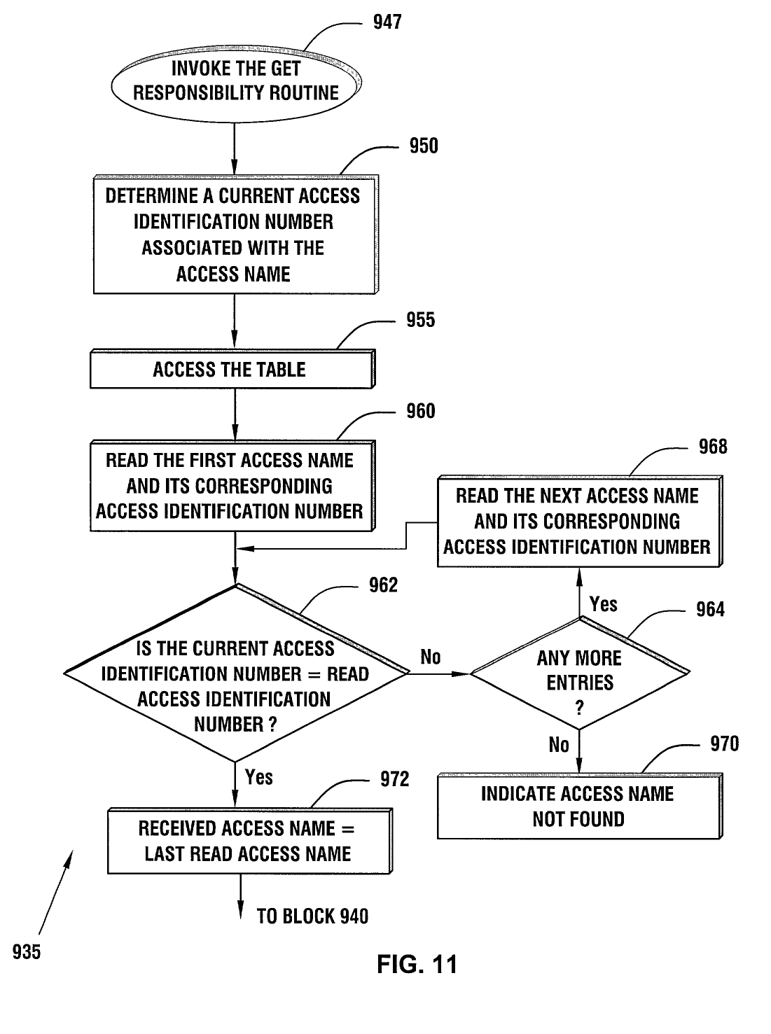

Referring again to FIG. 8, the database 289, in one embodiment, grants (at 870) a user access to the database 289 at the user access level in response to associating the access name to its corresponding access identification number. The user access level associated with the access name, in one embodiment, governs the level of access available to the user under that access name. As mentioned, the user access level may be defined in the profile 650 (see FIG. 7). The step of the block 870 of FIG. 8 is described in more detail below in FIGS. 10 and 11.

Referring now to FIG. 9, one embodiment of the table 280 is illustrated in accordance with the present invention. The table 280, in the illustrated embodiment, includes a plurality of sections 915(1-2) and a plurality of entries 920(1-p), with each entry 920(1-p) containing an exemplary access name and a corresponding access identification number. In one embodiment, the database server application 25 may generate the table 280 to store each access name that is created (at 810—see FIG. 8) and to store the corresponding access identification number of that access name.

In one embodiment, the table 280 may include two sections 915(1-2), one containing one or more access names associated with each user access level and another containing one or more access identification numbers that are associated with the access names. Thus, in one embodiment, each entry 920(1-p) of the table 280 may comprise an access name and the corresponding access identification number associated with that particular name. For example, the entry 920(1) contains an access name of first_access_name that has a corresponding access identification number of 0001. The entry 920(2), for example, contains an access name of second_access_name that has 0002 as a corresponding access identification number. The other entries 920(3-p) may contain similar information. The number of entries 920(1-p) in the table 280, in one embodiment, may depend on the number of access names the system administrator creates.

The table 280 may be organized in any suitable manner, and thus may be organized differently from one implementation to another. In one embodiment, the contents of the table 280 may be stored (in any desirable format) in an electronic file from which the contents of the file may be accessed. While the table 280 of FIG. 9 is shown as having lines that separate the sections 915(1-2) and/or entries 920(1-p), it should be noted, however, that these lines are for illustrative purposes only, and that they are not necessarily part of the table 280.

Referring now to FIG. 10, a flow diagram of a method of the block 870 of FIG. 8 is illustrated, in accordance with one embodiment of the present invention. The database 289 receives (at 921) an access name. In one embodiment, a user provides the access name to the database 289 under which the user accesses information stored in the database block 275. The access name, in one embodiment, may be a responsibility identifier that a user selects in Oracle database application.

The database 289 determines if a form is accessed (at 922) by the user under the received (at 921) access name. For example, the user may access one or more forms stored in the forms block 282. If a form is not accessed (at 922), then the database 289 may, in one embodiment, continue (at 925) with its normal operation. If a form is accessed (at 922), then, in one embodiment, the customizing module 284 is invoked (at 930). In the context of Oracle database application, the customizing module 284 may be a “custom.pll” file that is invoked when a new form is opened, for example.

The customizing module 284 determines (at 935) the access name that was entered by the user and received (at 921) by the database 289. In some instances, even though the user provides an access name to the database 289, there may not be a command or call available within the database 289 that allows the customizing module 284 to determine the received (at 921) access name. One method for determining the access name that is received (at 921) by the database 289 is described below with respect to FIG. 11. It may be desirable to determine the access name in instances when the user access level is defined based on access names (e.g., defining profiles (see, the profile 650—see FIG. 7) on an access name basis to control a user's access to the database 289).

Based on determining (at 935) the access name, the customizing module 284 accesses (at 940) the profile associated with that access name. And, based on the configuration of the associated profile (e.g., the profile 650 of FIG. 7), access is granted (at 945) to the user.

Referring now to FIG. 11, one embodiment of a flow diagram of the block 935 of FIG. 10 is illustrated, in accordance with the present invention. The customizing module 284 invokes (at 947), in one embodiment, the get access name module 288 (see FIG. 2), which, as described below, determines the access name that was provided by the user and received (at 921—see FIG. 10) by the database 289. The get access name module 288, in one embodiment, determines (at 950) a current access identification number that is associated with the access name that was received (at 921). As mentioned, the access identification number may, in one embodiment, be a reference number that is generated internally by the database 289 for each access name that is created. While in some instances it may not be possible to determine the access name that is received (at block 921—see FIG. 10), the current access identification number that is associated with that access name may be determined using a database command or call, in one embodiment. For example, in Oracle database application, the “fnd_profile_value” command may be utilized to determine the responsibility ID that is associated with the responsibility name.

The get responsibility routine 288 accesses (at 955) the table 280 (see FIG. 9). The get responsibility routine 288 reads (at 960) the first access name and its corresponding access identification number from the entry 920(1) of the table 280.

The get responsibility routine 288 determines (at 962) if the current access identification number is equal to the read (at 960) access identification number. If not, then the get responsibility routine 288 determines (at 964) if any more unread entries exist in the table 280. If so, then the next access name and its corresponding access identification number is read (at 968). The above steps, in one embodiment, are repeated until a match (at 962) between the current access identification number and the read (at 968) access identification number is found. If no match is found in the table 280, then the get responsibility routine 288 indicates (at 970) that the access name was not found, which, in one embodiment, may include generating an error message indicating that no matches were found in the table 280. In an alternative embodiment, instead of indicating (at 970) that the access name was not found, the get responsibility routine 288 may continue with normal operation instead. Once the current access identification number is found in the table 280, the get responsibility routine 288 determines (at 972) that the received access name is the access name that corresponds to the read access identification number that matched (at 962) the current access identification number.

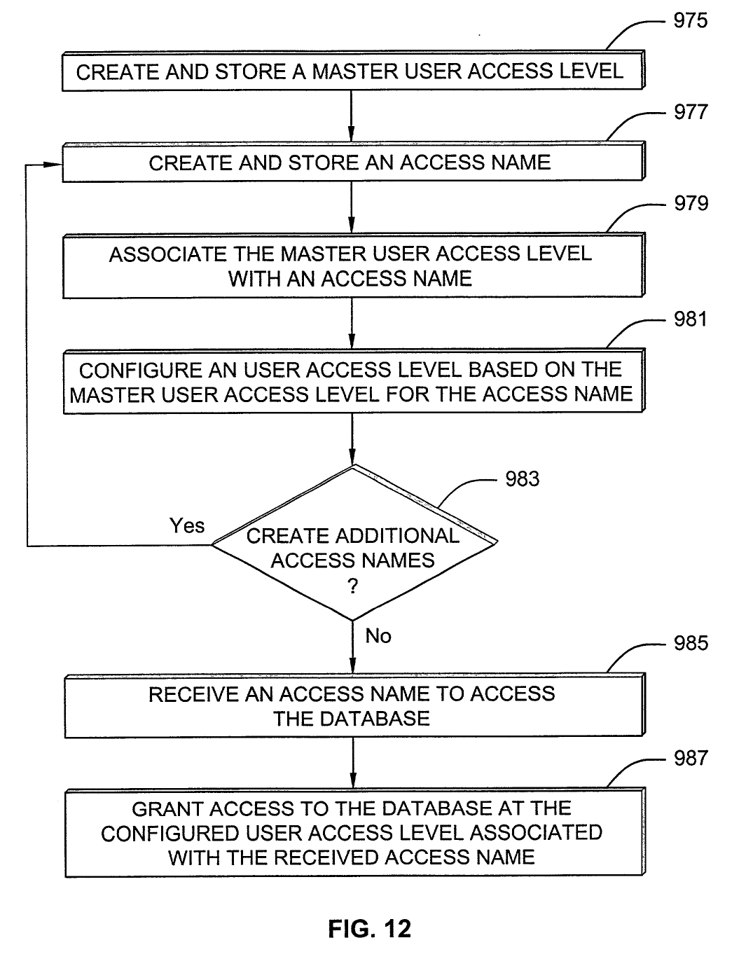

Referring now to FIG. 12, a flow diagram of a method that may be implemented in the server system 20 is illustrated, in accordance with one embodiment of the present invention. A system administrator creates and stores (at 975) a master profile, where the master profile represents, in one embodiment, all of the possible user access levels that may be configured to access the database 289. In one embodiment, the master profile may include an option to configure access to one or more of the forms that may be accessed through the database 289, or, alternatively, one or more of the forms for which access may be restricted. In one embodiment, the master profile may include options to configure blocks and/or fields of the forms that may be accessed through the database 289. In another embodiment, the master profile may include an option to configure all of the forms that may be accessible through database 289 for which the system administrator may desire to restrict user access. The access to these forms, in one embodiment, may be restricted by limiting accesses to selected blocks and/or fields of the forms.

The system administrator creates and stores (at 977) an access name. In one embodiment, the access name may be stored in the table 280 (see FIG. 2). The access name, in one embodiment, may correspond to a “responsibility identifier” in Oracle database application.

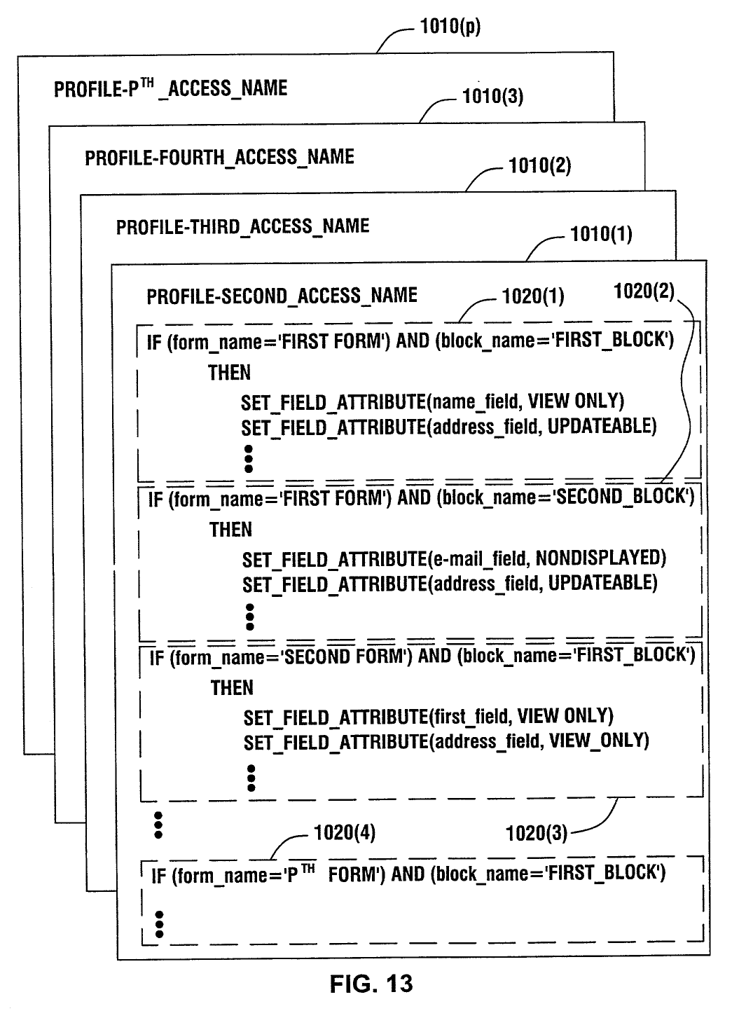

The system administrator associates (at 979) the master profile with an access name. That is, in one embodiment, the master profile may be copied and renamed for the access name that is created and stored (at 977). As described below, in one embodiment, a copy of the master profile may be made for each access name that is created to access the database 289. The system administrator configures (at 981) an user access level based on the master profile that is associated with the access name. Thus, for example, based on the level of access that should be given to the access name created and stored (at 977), the system administrator configures one or more options in the master profile to create a desired user access level. FIG. 13, which is described in more detail below, illustrates exemplary profiles that may be created from the master profile.

The system administrator determines (at 983) if creation of additional access names is desired. If yes, then the steps of the blocks 977, 979, and 981 are repeated until the desired access names have been created and a user access level (e.g., a profile) has been configured for each created access name, in one embodiment.

The workstation system 30(1-n) may receive (at 985) an access name from the user to access the database 289. The user is granted (at 987) access to the database 289 based on the user access level that is configured (at 981) for the received access name. In one embodiment, the user access level granted to a user accessing the database 289 is based on what was configured (at 981) previously from the master profile. Thus, in one embodiment, a profile configured from the master profile may define the user access level for the received access name.

Referring now to FIG. 13, a plurality of exemplary profiles 1010(1-p) that may have been created from a master profile and then stored in the profile block 286 (see FIG. 2) are illustrated, in accordance with one embodiment of the present invention. In one embodiment, at least one profile 1010(1-p) may be generated for each access name that is defined in the database 289, where each profile 1010(1-p) may define access to selected fields in one or more of the forms stored in the forms block 282. In one embodiment, each profile 1010(1-p) may be created from a master profile that includes configurable options for each form, on a block and/or field basis. Once created from the master profile, each profile 1010(1) is configured to define access on an access name basis, as shown in FIG. 13. That is, as described below, each profile 1010(1-p) defines access to the database 289 on an access name basis, and as such, in one embodiment, the profiles 1010(1-p) may have the same configurable options, except the configuration may be customized for each access name.

FIG. 13 illustrates an exemplary profile 1010(1) for access name “second_access_name.” The profile 1010(1), in one embodiment, may include a plurality of sections 1020(1-4), where each section may define access to selected blocks within each form. For example, the section 1020(1) sets the attribute of the “name_field” and “address_field” to view only and updateable, respectively, in the FIRST block of the FIRST form. As another example, the section 1020(2) sets the attribute of the “e-mail_field” and the “address_field” to non-displayed and updateable, respectively, of the SECOND block of the FIRST form. Access to selected fields of the remaining forms that may be accessible by the database 289 may be defined for the access name “second access name” in the profile 1010(1).

In one embodiment, each access profile 1010(1-p) for each access name may include all of the possible forms that may be available through the database 289, including pre-existing forms (i.e., shipped by the provider of the database) or newly created ones. By having all of the forms listed in each profile 1010(1-p), system administrators may be able to conveniently and expeditiously configure access for each access name by simply editing the relevant attributes for the fields in that form. For example, to allow “second_access_name” to be able to update the “name_field” in the FIRST block of the FIRST name, the system administrator may simply edit the entry for the “name_field” of the first section 1020(1) to replace the attribute “view only” to “updateable.” Similarly, the system administrator, for each access name, can control access to selected fields of the one or more forms that are accessible by the database 289 through the use of profiles, in accordance with one embodiment of the present invention.

Some embodiments of the present invention may reduce the dependency on access identification numbers that are associated with access names, and, as a result, make it easier in some instances to transport the profiles (e.g., the profile 650 or profiles 1010(1-p) from FIGS. 7 and 13, respectively) from one database to another, as explained below. Additionally, as described below, some embodiments of the present invention may make it simpler for a system administrator to control access to the database 289 because of the reduced dependency on access identification numbers.

Typically, access identification numbers are assigned to access names in the order the access names are created by the database 289, and, as such, the access identification numbers associated with the access names may vary if the access names are created in databases in a different order. For example, access names created on one database may have different access identification numbers associated with them than if they were created on another database, particularly if the access names are created in a different order in the two databases. As such, with this mismatch between the access identification number and access name association it may sometimes make it difficult to transfer user access level information from one database to another. However, as described above, one or more embodiments of the present invention enable system administrators to control access to databases independent of the access identification numbers that are assigned to the access names. This is, in part, because the user access levels (e.g., based on the profile 650—FIG. 7), in one embodiment, are defined based on access names, which may then be associated to access identification numbers, for example, by the get access name module 288 (see FIG. 2).

The ability to control access to the database 289 substantially independently of the assigned access identification number may be desirable in several instances, such as if the database 289 becomes corrupt and new access names need to be recreated or if the profile block 286 (see FIG. 2) containing the profiles needs to be migrated to a different database where access names may need to be created. If the access names need to be recreated because of corruption, with the advent of one or more embodiments of the present invention, the order in which the access names may not be significant.

In accordance with some embodiments of the present invention, the use of the task flow enables system administrators to control a user's access to selected form or forms within the database 289. Additionally, with the use of profiles (e.g., the profile 650—FIG. 7), one or more embodiments of the present invention allow the system administrators to restrict user access to selected fields within the task flow or within one or more forms that may be accessible through the database 289. As described, the access to selected fields may be, for example, view-only, updateable, hidden, and the like. The ability to control access at a form level, and then at field level, may allow system administrators to provide a more robust way of controlling user access to the information stored within the database 289, in one embodiment.

The various system layers, routines, or modules may be executable control units (such as control unit 215 (see FIG. 2)). Each control unit may include a microprocessor, a microcontroller, a processor card (including one or more microprocessors or controllers), or other control or computing devices. The storage devices referred to in this discussion may include one or more machine-readable storage media for storing data and instructions. The storage media may include different forms or memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. An apparatus, comprising:
a storage unit; and
a controller communicatively coupled to the storage unit, the controller adapted to:
store a master profile for accessing a database in the storage unit;
store a user access name to access the database in the storage unit; and
configure a user access level based on the master profile and the access name.

2. The apparatus of claim 1, wherein the controller is further adapted to allow access to the database at the user access level using the access name.

3. The apparatus of claim 1, wherein the controller is further adapted to store a plurality of access names.

4. The apparatus of claim 3, wherein the controller is adapted to configure a plurality of user access levels based on the master profile, wherein at least one user access level is configured for each of the plurality of access names.

5. The apparatus of claim 1, wherein the controller is adapted to store a master profile having an option to configure one or more forms that are accessible from the database.

6. The apparatus of claim 5, wherein the controller is adapted to store the master profile having options to configure access for one or more fields of the forms that are accessible from the database.

7. The apparatus of claim 5, wherein the controller is adapted to make a copy of the master profile and configure the copy of the master profile based on an access level desired for the access name.

8. The apparatus of claim 1, wherein the controller is adapted to configure at least one user access level for each stored access name.

9. The apparatus of claim 1, wherein the database is Oracle database.

10. The apparatus of claim 1, wherein the master profile comprises an option to configure access for all of the forms that are accessible from the database.

11. An article comprising at least one machine-readable storage medium containing instructions for configuring access to a database, the instructions when executed enable a processor to:
store a master profile for accessing the database in the storage unit, wherein the master profile defines a user access level for accessing the database;
store a user access name to access the database in the storage unit; and
configure a profile based on the master profile and access level desired for the access name.

12. The article of claim 11, wherein the instructions when executed enable the processor to allow access to the database at the user access level with the access name.

13. The article of claim 11, wherein the instructions when executed enable the processor to store a plurality of access names and configure a profile for each of the plurality of access names.

14. The article of claim 11, wherein the instructions when executed enable the processor to make a copy of the master profile and configure the copy of the master profile based on an access level desired for the access name.

15. The article of claim 11, wherein the instructions when executed enable the processor to store the profile having options to configure access to one or more forms that are accessible from the database.

16. The article of claim 11, wherein the instructions when executed enable the processor to store the profile having options to configure access to one or more fields of the one or more forms that are accessible from the database.

17. The article of claim 11, wherein the instructions when executed enable the processor to store the master profile in the storage unit for accessing Oracle database.

18. A method comprising:
storing a first user access level for accessing a database in the storage unit, wherein the first user access level comprises options to configure all of the forms accessible through the database;
storing a user access name to access the database in the storage unit; and
configuring a user access level based on the first user access level and access level desired for the access name.

19. The method of claim 18, wherein configuring the user access level comprises configuring the options to allow access to selected fields of at least a portion of the forms.

20. The method of claim 18, wherein configuring the user access level comprises configuring the options to deny access to selected fields of at least a portion of the forms.

21. The method of claim 18, wherein configuring the user access level comprises configuring a profile containing options to configure all of the forms accessible through the database based on the first user access level and access level desired for the access name.

22. The method of claim 18, comprising configuring a profile containing options to configure all of the forms accessible through the database for each user access name stored in the storage unit.

23. The method of claim 18, wherein storing a first user access level comprises storing a profile containing options to configure all of the forms accessible through the database.

24. The method of claim 18, comprising storing the user access name to access Oracle database.

25. An apparatus, comprising:
an interface; and
a controller communicatively coupled to the interface, the controller adapted to:
receive a user access name from the interface;
access a master profile configured to provide the user access name to the database at a first user access level; and
allow access to the database at the first user access level.

26. The apparatus of claim 25, wherein the controller is adapted to allow access to one or more forms accessible by the database.

27. The apparatus of claim 26, wherein the controller is adapted to allow access to selected fields within the one or more forms.

28. The apparatus of claim 25, wherein the controller is adapted to receive a responsibility identifier from the interface to access Oracle database.

29. The apparatus of claim 23, wherein the interface comprises a network interface.

30. An article comprising at least one machine-readable storage medium containing instructions for configuring access to a database that can access one or more forms, the instructions when executed enable a processor to:
store one or more options in a profile to control access to all of the forms in the database for which access may be restricted;
store a user access name to access the database; and
configure the one or more options in the profile to grant selected access to one or more fields of the forms based on an access level desired for the access name.

31. The article of claim 30, wherein the instructions when executed enable the processor to store a plurality of user access names and to configure a profile for each one of the plurality of user access names.

32. The article of claim 30, wherein the instructions when executed enable the processor to receive the user access name and allow access to the database based on the profile configuration associated with the received user access name.
